(19) United States
(12) Patent Application Publication
(10) Pub. No.: US 2008/0070820 A1
(43) Pub. Date: Mar. 20, 2008

(54) Stain removing cleaning solutions

(75) Inventors: Kevin M. Mullen, Smithfield, UT (US); Barry O. Stokes, Logan, UT (US); Patti A. Nelson, Paradise, UT (US)

Correspondence Address: THORPE NORTH & WESTERN, LLP., 8180 SOUTH 700 EAST, SUITE 350, SANDY, UT, 84070, US

(73) Assignee: WESCOR, INC., Logan, UT (US)

(21) Appl. No.: 11/523,894

(22) Filed: Sep. 19, 2006

(51) Int. Cl. C02F 5/08

(52) U.S. Cl. 510/253

(57) ABSTRACT

Cleaning solutions and related methods for cleaning and removing stains and residues from items and surfaces such as laboratory equipment and surfaces uses cleaning solutions containing from about 25 wt % to about 99 wt % of a liquid sulfoxide and from about 1 wt % to about 75 wt % of a base-water solution. A variety of bases can be used in the base-water solution so long as the base-water solution has a pH of at least about 8. The cleaning solutions are particularly fast and effective in cleaning stains caused by biological staining reagents and solutions. A preferred embodiment of the cleaning solution contains between about 80 wt % liquid sulfoxide, such as dimethyl sulfoxide (DMSO), and between about 10 wt % and about 20 wt % base-water solution, such as a 4.5% potassium hydroxide-water solution.

### BACKGROUND OF THE INVENTION

The present invention relates generally to chemical cleaning solutions. More particularly, the present invention relates to cleaning solutions for use in removing stains from laboratory equipment, surfaces, and other objects.

Stains and residue build-ups are common occurrences in chemical and biological laboratories. The causes of the stains can vary and include a wide variety of compounds and agents. One common source of stains in laboratories is biological staining agents. These agents are used, for example, for staining biological specimens, but, can be spilled on laboratory surfaces, clothing, and other objects. In addition, automated staining equipment is often used for such staining and the staining agents build up on and in the staining equipment. Regardless of the cause of the stain or residue build-up, left uncleaned, they can result in problems including poor laboratory conditions, undesired contamination, malfunction or damage to equipment, etc.

Many cleaning solutions are currently available, but each has various drawbacks. Some are not effective on tough stains or can require excessive scrubbing. Another common problem is the amount of time it can take for the cleaning solution to actually remove the stain or residue. As such, research continues to find a cleaning solution that can provide fast and effective cleaning of a broad range of stains and residues, particularly on laboratory surfaces and in laboratory equipment.

### SUMMARY OF THE INVENTION

According to the invention, a mixture of a liquid sulfoxide and a base-water solution having a pH of at least about 8. provides effective cleaning and removal of stains and residues, particularly stains and residues caused by biological staining agents such as Wright, Giemsa, and Romanowsky staining reagents (thiazin and eosin stains), Gram staining reagents (iodine, crystal violet, and safranine stains), Acid Fast staining reagents (carbol fuchsin, methylene blue, and brilliant green), and Fluorescent staining reagents (auramine, and auramine rhodamine).

The present invention is drawn to cleaning solution compositions and related methods which can provide both fast and effective removal of a broad range of stains and residues. The cleaning solutions of the invention contain between about 25 wt % to about 99 wt % of a liquid sulfoxide and from about 1 wt % to about 75 wt % of a base-water solution. A preferred embodiment of the present invention provides a cleaning solution containing from about 70 wt % to about 99 wt % of a liquid sulfoxide and from about 1 wt % to about 30 wt % of a base-water solution. The base-water solution used in the compositions has a pH of at least about 8. A further preferred embodiment of the invention contains about 80 wt % to about 90 wt % of a liquid sulfoxide and about 10 wt % to about 20 wt % of a base-water solution with the pH of the base-water solution being at least about 12, and preferably about 13.5.

The invention also provides a method of cleaning laboratory equipment and laboratory surfaces. The method involves contacting laboratory equipment or a laboratory surface having a stain thereon with an effective amount of a cleaning solution having from about 25 wt % to about 99 wt % of a liquid sulfoxide and from about 1 wt % to about 25 wt % of a base-water solution. The base-water solution used in the composition has a pH of at least about 8. In addition to laboratory equipment and laboratory surfaces, the method can be used for removing and cleaning stains from clothing, carpet, and other items and materials which are compatible with the solution. By compatible with the solution, it is meant that it should be realized that some sulfoxides attack some plastics and other materials. Thus, care should be taken to be sure that the particular cleaning solution composition will not attack the materials to be cleaned. For example, DMSO, a preferred liquid sulfoxide, acts as a solvent against lexan plastic. However, it has been found that for cleaning solutions of the invention with at least about 10 wt % of the base-water sloution, the solvent action of DMSO against lexan is eliminated. Thus, cleaning solutions of the invention with about 10 wt % or more of base-water solution can be used to clean lexan surfaces and parts.

### DETAILED DESCRIPTION OF EXAMPLE EMBODIMENTS

The invention is related to novel cleaning solutions and associated methods for their use. The cleaning solutions quickly and readily dissolve and remove stains and residues which are commonly found in laboratories. In particular, the cleaning solutions of the present invention are effective for removing stains caused by biological staining reagents. Non-limiting examples of stains which can be removed by the cleaning solutions of the present invention include stains caused by Wright, Giemsa, and Romanowsky staining reagents (thiazin and eosin stains), Gram staining reagents (iodine, crystal violet, and safranine stains), Acid Fast staining reagents (carbol fuchsin, methylene blue, and brilliant green), and Fluorescent staining reagents (auramine, and auramine rhodamine).

The cleaning solutions of the present invention are capable of removing stains from a variety of substrates and surfaces. The cleaning solution can remove stains or residues from relatively hard substrates such as countertops, sinks, floors, stainless steel, glassware, plastics, instruments, laboratory equipment, etc. As the cleaning solutions of the present invention are particularly effective for removing stains caused by biological staining reagents, they are particularly useful in cleaning staining apparatus, particularly automated staining apparatus, and counter tops and other surfaces where such staining reagents may be spilled. The cleaning solutions can also be effective for removing stains from clothing, carpet, and both woven and non-woven materials. Although the invention is primarily focused on removal of stains which frequently occur in laboratories, the inventors also recognize its effectiveness at removing non-laboratory related stains such as household and commercial stains of biological and non-biological origin.

The cleaning solutions can be applied or contacted with the surfaces to be cleaned in a number of ways depending on the type of surface being cleaned and the nature of the stain or source of the stain. In one aspect of the invention, the cleaning solution can be sprayed or poured directly onto the stained surface. In another aspect, the cleaning solution can be applied to a cleaning instrument which in turn can be used to contact or apply the cleaning solution to the stained surface. Examples of cleaning instruments which can be used in connection with the cleaning solutions of the present invention include but are not limited to cloths, paper towels, sponges, brushes, and other woven and non-woven materials. The cleaning solutions of the present invention can also be used as soaking baths into which stained surfaces, such as stained instruments or instrument components, such as tubing and nozzles, can be placed. In addition, the cleaning solutions can be run through the equipment to clean flow lines, nozzles, and chambers. Depending on the nature of the stain, some wiping or scrubbing of the stain with the cleaning solution may be required to either accelerate cleaning or completely remove the stain or residue.

The cleaning solutions of the present invention are formulated to include from about 25 wt % to about 99 wt % of a liquid sulfoxide and from about 1 wt % to about 75 wt % of a base-water solution. The base-water solution used in the cleaning solutions can be made by combining a base and water together so as to produce a solution with a pH of at least about 8. In one embodiment, the base-water solution has a pH of at least about 10. In another embodiment, the base-water solution has a pH of at least about 12. In yet another embodiment, the base-water solution has a pH of at least about 13.5.

Generally, any liquid sulfoxide known in the art can be used in the present invention, although economic factors can influence the selection. Also, the particular cleaning to be done can influence the selection so that the liquid sulfoxide chosen is compatible with the material or items to be cleaned. Examples of liquid sulfoxides which can be used in the present invention are dimethyl sulfoxide (DMSO), n-butyl sulfoxide, tetrahydrothiophene oxide, and mixtures thereof. One preferred liquid sulfoxide is dimethyl sulfoxide (DMSO). DMSO is advantageous in that it is generally equally as effective as other liquid sulfoxides and economically reasonable. The amount of liquid sulfoxide present in the cleaning solution can vary over a range of from about 25 wt % to about 99 wt %. This range was shown to be effective at removing stains when combined with a base-water solution with a pH of at least about 8. A cleaning solution containing between about 70 wt % and about 99 wt % liquid sulfoxide and between about 1 wt % and about 30 wt % base-water solution has been found particularly effective at quickly and easily removing stains and residues.

In one embodiment of the present invention, the liquid sulfoxide is present in an amount of from about 80 wt % to about 90 wt %, with the remainder being the base-water solution. In another embodiment, the liquid sulfoxide is present in the cleaning solution in an amount of about 80 wt % and the base-water solution is present in an amount of about 20 wt %. It was discovered that cleaning solutions with about 80 wt % to about 90 wt % liquid sulfoxide and having a base-water solution with a pH of at least about 8 provides enhanced cleaning over cleaning solutions having less than about 80 wt % and more than about 95 wt % liquid sulfoxide, and it was further discovered that with at least about 10 wt % of the base-water solution present, the solvent action of DMSO against lexan plastic is substantially eliminated, thus making the cleaning solution chemically compatible with lexan plastic. These cleaning solutions are not only capable of removing high percentages of stains and residues but are able to do so quickly and without attacking lexan plastic, a component of some automatic staining equipment.

The base-water solution used in the cleaning solutions of the present invention can be formulated using bases known in the art, so long as the base is sufficiently strong to create a pH in the base-water solution of at least about 8. The amount of base required to achieve the necessary pH can vary depending on the base or mixture of bases used. Non-limiting examples of bases which can be used include potassium hydroxides, potassium alkoxides, sodium hydroxides, sodium alkoxides, ammonia, organic amines, and mixtures thereof.

As stated above, the amounts of base in the base-water solution of the present invention can vary depending on the strength of the base used. However, it is important that the base be present in an amount sufficient to achieve a pH in the base-water solution of at least about 8. Generally, higher pH values were shown to provide faster, and in some cases more effective, cleaning. In one embodiment, the base is present in an amount sufficient to achieve a pH in the base-water solution of at least about 10. In a further embodiment, the base is present in an amount sufficient to achieve a pH in the base-water solution of at least about 12. In yet another embodiment, the base is present in an amount sufficient to achieve a pH in the base-water solution of about 13.5.

### EXAMPLE

Cleaning solutions containing varying amounts of dimethyl sulfoxide and a 4.5% KOH—H₂O base-water solution were prepared as shown in Table I. The strength and effectiveness of each solution was tested by soaking a piece of stained tubing (˜0.1 inches in length) in about 5 ml of the cleaning solution for a period of about 5 minutes, unless a shorter time is indicated. The cleaning effectiveness indicated was determined by observation and agreement of the inventors. The 4.5% KOH-H₂O base-water solution used had a pH of about 13.5. The pH of the cleaning solution after mixing could not be accurately measured, but it is believed that the cleaning solution takes on the approximate pH value of the base-water solution.

TABLE I

Cleaning Solution Formulation

| | 4.5% KOH—H₂O | Percent Clean after 5 |
|---|---|---|
| DMSO (wt %) | (wt %) | minutes |
| 100 | 0 | 10 |
| 99 | 1 (0.045% KOH) | 90 |
| 95 | 5 (0.225% KOH) | 100 (completely clean |
| | | in 1.25 minutes) |
| 90 | 10 (0.45% KOH) | 100 (completely clean at |
| | | 1.5 minutes) |
| 80 | 20 (0.9% KOH) | 100 (completely clean at |
| | | 2.0 minutes) |
| 70 | 30 (1.35% KOH) | 85 |
| 50 | 50 (2.25% KOH) | 60 |
| 25 | 75 (3.38% KOH) | 25 |
| 0 | 100 (4.5% KOH) | 10 |

It should be noted from the above table that neither the DMSO alone nor the 4.5% KOH—H₂O base-water solution alone provided satisfactory cleaning. Each of the DMSO alone and the 4.5% KOH—H₂O base-water solution alone provided only 10% cleaning of the stains from the stained tubing after five minutes of soaking the tubing. However, it was found that by the addition of only 1 wt % of the base-water solution to the liquid sulfoxide, i.e., the addition of only 1 wt % 4.5% KOH—H₂O base-water solution to the DMSO, that excellent cleaning was obtained. Thus, the above table shows that with 1 wt % of the 4.5% KOH—H₂O base-water solution and 99 wt % DMSO, the resulting cleaning solution of the invention provided 90% cleaning of the stained tubing after five minutes of soaking. Further addition of base-water solution showed striking results in that with 5 wt % of the 4.5% KOH—H₂O base-water solution and 95% DMSO (resulting cleaning solution composition: 95 wt % dimethyl sulfoxide (DMSO), 0.225 wt % potassium hydroxide (KOH), and 19.775 wt % de-ionized water), the tubing was 100 per cent clean after only 1.25 minutes of soaking. With 90 wt % DMSO and 10 wt % of the 4.5% KOH—H₂O base-water solution (90 wt % dimethyl sulfoxide (DMSO), 0.45 wt % potassium hydroxide (KOH), and 19.55 wt % de-ionized water), the tubing was 100 per cent clean after 1.5 minutes of soaking. With 80 wt % DMSO and 20 wt % of the 4.5% KOH—H₂O base-water solution (80 wt % dimethyl sulfoxide (DMSO), 0.9 wt % potassium hydroxide (KOH), and 19.1 wt % de-ionized water), the tubing was 100 per cent clean after 2 minutes of soaking. With further addition of the base-water solution, the effectiveness of the cleaning dropped off so that with 70 wt % DMSO and 30 wt % of the 4.5% KOH—H₂O base-water solution, the tubing was only 85% clean after five minutes of soaking. Cleaning effectiveness had dropped off to 60% clean after soaking for five minutes in a 50% DMSO and 50% 4.5% KOH—H₂O base-water solution, and to 25% clean after five minutes of soaking in a 25% DMSO and 75% 4.5% KOH—H₂O base-water solution. However, even at the 25% or 60% cleaning effectiveness, the cleaning solution is satisfactory for some uses. A cleaning solution that is 85% or above effective is satisfactory for many uses. Thus, an effective cleaning solution is provided by a 25% DMSO or above with a very effective cleaning solution provided by 70% DMSO or above.

While the most effective and fastest cleaning came from the solution having 95 wt % dimethyl sulfoxide (DMSO) and 5% of the 4.5% KOH—H₂O base-water solution, the cleaning solution containing 80 wt % dimethyl sulfoxide (DMSO) and 20 wt % of the 4.5% KOH—H₂O base-water solution achieved the equivalent 100% cleaning effectiveness as the 95% DMSO cleaning solution after only 45 seconds additional cleaning time. In addition, as indicated above, a cleaning solution which includes at least 10 wt % base-water solution does not affect lexan plastic. Since the particular automatic slide staining equipment mentioned earlier in the application includes several lexan parts that collect staining reagents and need periodic cleaning, a composition which does not affect lexan plastic is currently preferred. Thus, it currently appears that optimal results are obtained with any composition between about 80 wt % to about 90 wt % of liquid sulfoxide and between about 10 wt % and 20 wt % of base-water solution. When factoring in the cost of the DMSO, currently the most economical liquid sulfoxide, as compared to the cost of the base-water solution, the 80 wt % liquid sulfoxide and 20 wt % base-water solution combination becomes the currently most preferred cleaning solution of the invention.

The invention also includes the method of cleaning laboratory equipment and laboratory surfaces by contacting the laboratory equipment or a laboratory surface having a stain or residue thereon with an effective amount of a cleaning solution having from about 25 wt % to about 99 wt % of a liquid sulfoxide and from about 1 wt % to about 25 wt % of a base-water solution for a sufficient amount of time to remove the stain or residue. Preferably, the cleaning solution contains between about 70 wt % and about 99 wt % liquid sulfoxide and about 1 wt % to about 30 wt % base-water solution. More preferably the cleaning solution contains between about 80 wt % and about 90 wt % liquid sulfoxide and between about 10 wt % to 20 wt % base-water solution. The base-water solution has a pH of at least about 8, preferably of at least about 12, and most preferably a pH of about 13.5. In addition to laboratory equipment and laboratory surfaces, the method can be used for removing and cleaning stains and residues from clothing, carpet, and other items and materials which are compatible with the solution.

In carrying out the method, the cleaning solution can be sprayed or poured directly onto the surface or item to be cleaned, or can be applied by a cleaning instrument which in turn is used to contact or apply the cleaning solution to the stained surface. For example, the cleaning solution of the present invention can be applied to the surface or item to be cleaned by cloths, paper towels, sponges, brushes, and other woven and non-woven materials. Alternatively, an item to be cleaned can be placed in a bath of the cleaning solution, or the cleaning solution can be run through equipment to be cleaned. Some wiping or scrubbing of the surface or item to be cleaned with the cleaning solution may be required to completely remove the stain or residue. For wiping and scrubbing of the surface or item, application of the cleaning solution with cloths, paper towels, sponges, brushes, or other materials is advantageous.

While the forgoing examples are illustrative of the principles of the present invention in one or more particular applications, it will be apparent to those of ordinary skill in the art that numerous modifications in form, usage, and details of implementation can be made without the exercise of inventive faculty, and without departing from the principles and concepts of the invention. Accordingly, it is not intended that the invention be limited, except as by the claims set forth below.

1. A cleaning solution comprising:
a) from about 25 wt % to about 99 wt % of a liquid sulfoxide, and
b) from about 1 wt % to about 75 wt % of a base-water solution, wherein the base-water solution has a pH of at least about 8.

2. The cleaning solution of claim 1, wherein the base in the base-water solution is selected from the group consisting of potassium or sodium hydroxides, potassium or sodium alkoxides, ammonia, organic amines, and mixtures thereof.

3. The cleaning solution of claim 1, wherein the base in the base-water solution is potassium hydroxide.

4. The cleaning solution of claim 3, wherein the base-water solution is a 4.5 wt % potassium hydroxide-water solution.

5. The cleaning solution of claim 3, wherein the potassium hydroxide comprises from about 0.045 wt % to about 3.38 wt % of the cleaning solution.

6. The cleaning solution of claim 3, wherein the potassium hydroxide comprises from about 0.45 wt % to about 0.9 wt % of the cleaning solution.

7. The cleaning solution of claim 1, wherein the pH of the base-water solution is at least about 12.

8. The cleaning solution of claim 1, wherein the liquid sulfoxide is selected from the group consisting of dimethyl sulfoxide, n-butyl sulfoxide, tetrahydrothiophene oxide, and mixtures thereof.

9. The cleaning solution of claim 1, wherein the liquid sulfoxide is dimethyl sulfoxide.

10. The cleaning solution of claim 1, wherein the liquid sulfoxide comprises from about 80 wt % to about 90 wt % of the cleaning solution.

11. A cleaning solution comprising:
a) from about 25 wt % to about 99 wt % dimethyl sulfoxide (DMSO),
b) from about 0.045 wt % to about 3.38 wt % potassium hydroxide, and
c) from about 0.955 wt % to about 71.62 wt % water.

12. The cleaning solution of claim 11, wherein the DMSO comprises from about 80 wt % to about 90 wt % of the cleaning solution.

13. The cleaning solution of claim 11, wherein the potassium hydroxide comprises from about 0.45 wt % to about 0.9 wt % of the cleaning solution.

14. The cleaning solution of claim 11, wherein water comprises from 9 wt % to 19.1 wt % of the cleaning solution.

15. A method of cleaning items and surfaces, comprising contacting said item or surface with an effective amount of a cleaning solution, said cleaning solution comprising:
a) from about 25 wt % to about 99 wt % of a liquid sulfoxide, and
b) and about 1 wt % to about 75 wt % of a base-water solution, wherein the base-water solution has a pH of at least about 8.

16. The method of claim 15, wherein the item is laboratory equipment.

17. The method of claim 15, wherein the surface is a laboratory surface selected from the group of countertops, sinks, floors, stainless steel, plastics, carpets, and clothing.

18. The method of claim 15, wherein the cleaning is done to remove stains or residue from the item or surface.

19. The method of claim 18, wherein the stain or residue was caused by compositions used to stain biological specimens.

20. The method of claim 19, wherein the compositions used to stain biological specimens is a Wright stain, a Giemsa stain, a Romanowsky stain, a Gram stain, an Acid Fast stain, or a Fluorescent stain.

21. The method of claim 15, wherein contacting item or surface with the cleaning solution is accomplished by a method selected from the group of soaking, spraying, pouring, wiping, and scrubbing.

22. The method of claim 15, wherein the base in the base-water solution is selected from the group consisting of potassium or sodium hydroxides, potassium or sodium alkoxides, ammonia, organic amines, or mixtures thereof.

23. The method of claim 15, wherein the base in the base-water solution is potassium hydroxide.

24. The method of claim 15, wherein the pH of the base-water solution is at least about 10.

25. The method of claim 15, wherein the pH of the base-water solution is at least about 13.5.

26. The method of claim 15, wherein the liquid sulfoxide is selected from the group consisting of dimethyl sulfoxide, n-butyl sulfoxide, tetrahydrothiophene oxide, and mixtures thereof.

27. The method of claim 15, wherein the liquid sulfoxide is dimethyl sulfoxide.

28. The method of claim 15, wherein the liquid sulfoxide comprises from about 80 wt % to about 90 wt % of the cleaning solution.

29. A method of removing stains and residues from items or surfaces, comprising contacting the item or surface with an effective amount of a cleaning solution comprising:
a) from about 25 wt % to about 99 wt % dimethyl sulfoxide (DMSO),
b) from about 0.045 wt % to about 3.38 wt % potassium hydroxide, and
c) from about 0.955 wt % to about 71.62 wt % water.

30. A method of removing stains and residues caused by biological staining compositions, comprising contacting the stain or residue with an effective amount of a cleaning solution comprising:
a) from about 80 wt % to about 90 wt % dimethyl sulfoxide (DMSO),
b) from about 0.45 wt % to about 1.35 wt % potassium hydroxide, and
c) from about 9 wt % to about 19.5 wt % water.
